(19) United States
(12) Patent Application Publication
(10) Pub. No.: US 2025/0139818 A1
(43) Pub. Date: May 1, 2025

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventor: KENJI GOTOH, TOKYO (JP)

(21) Appl. No.: 18/837,865

(22) PCT Filed: Dec. 26, 2022
(86) PCT No.: PCT/JP2022/047824

§ 371 Date: Aug. 12, 2024

(30) Foreign Application Priority Data
Feb. 18, 2022 (JP) 2022-023448

(51) Int. Cl. G06T 7/73; G06V 10/44

(52) U.S. Cl. CPC G06T 7/73; G06V 10/44; G06T 2207/30196

(57) ABSTRACT

[Object] To correct for an offset between frames of images generated by a plurality of image-capturing apparatuses.

[Solving Means] An information processing apparatus includes an offset calculator that calculates an amount of an offset between a feature-point group and a three-dimensional pose-point group for each frame, the feature-point group being detected in a frame image that is generated by each of at least one of a plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group; calculates a first index value α for each frame on the basis of the offset amounts; calculates a second index value β on the basis of a plurality of the first index values α calculated for the respective frames; and calculates a frame-offset value R for the adjustment-target image-capturing apparatus on the basis of the second index value β.

### TECHNICAL FIELD

The present disclosure relates to an information processing apparatus, an information processing method, and an information processing program that are used to calculate frame-offset values for a plurality of image-capturing apparatuses.

### BACKGROUND ART

There is a technology used to capture images of one object using a plurality of image-capturing apparatuses for the same period of time to generate respective two-dimensional images, and to calculate a three-dimensional pose of the object on the basis of the generated two-dimensional images. There is a need to match frames of two-dimensional images generated by a plurality of image-capturing apparatuses to each other, in order to calculate a three-dimensional pose accurately.

### CITATION LIST

### Patent Literature

Patent Literature 1: Japanese Patent Application Laid-open No. 2004-354257

Patent Literature 2: Japanese Patent Application Laid-open No. 2000-40147

Patent Literature 3: Japanese Patent Application Laid-open No. 2002-8040

### DISCLOSURE OF INVENTION

### Technical Problem

When image-capturing starting timings of a plurality of image-capturing apparatuses are offset, frames of two-dimensional images generated by the plurality of image-capturing apparatuses may be offset, and this may result in failing to calculate a three-dimensional pose accurately.

Patent Literature 1 discloses extracting a feature point from an image to perform markerless calibration. Patent Literatures 2 and 3 disclose selecting, from a plurality of image-capturing apparatuses and using image information, an image-capturing apparatus to be used to perform recognition and to calculate a three-dimensional position. On the other hand, it is assumed, in all of Patent Literatures 1 to 3, that image-capturing apparatuses perform image-capturing in synchronization with each other, and no consideration may be given to an offset between frames for the respective image-capturing apparatuses.

In view of the circumstances described above, an offset between frames of images generated by a plurality of image-capturing apparatuses is desired to be corrected for.

### Solution to Problem

An information processing apparatus according to an embodiment of the present disclosure includes a frame-image group acquiring section and an offset calculator. The frame-image group acquiring section acquires a plurality of frame-image groups respectively generated by images of one object being respectively captured by a plurality of image-capturing apparatuses for the same period of time, each of the plurality of frame-image groups including a plurality of frame images. The offset calculator acquires a three-dimensional pose-point group of the object that is calculated for each frame on the basis of feature-point groups that are respectively detected in the plurality of frame images that is included in each of the plurality of frame-image groups; calculates an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group; calculates a first index value α for each frame on the basis of the offset amounts; calculates a second index value β on the basis of a plurality of the first index values a calculated for the respective frames; and calculates a frame-offset value R for the adjustment-target image-capturing apparatus on the basis of the second index value β.

As described above, the offset calculator determines the respective frame-offset values R for all of the image-capturing apparatuses. Accordingly, frame-offset values R for images respectively generated by the plurality of image-capturing apparatuses can be determined in a state in which frames of the images respectively generated by the plurality of image-capturing apparatuses are offset due to image-capturing starting timings of the plurality of image-capturing apparatuses being offset and this may result in failing to calculate a three-dimensional pose accurately.

The first index value α may be an average of amounts of an offset between the frame images respectively generated by the at least two of the plurality of image-capturing apparatuses.

Consequently, the frame-offset value R for the adjustment-target image-capturing apparatus is calculated on the basis of the average (the first index value α) of amounts of an offset between the frame images respectively generated by the at least two of the plurality of image-capturing apparatuses. Thus, an appropriate frame-offset value R can be calculated for the adjustment-target image-capturing apparatus.

The second index value β may be an average of the plurality of the first index values α.

Consequently, the frame-offset value R for the adjustment-target image-capturing apparatus is calculated on the basis of an average (the second index value β) of the averages (the first index values α) of amounts of offsets between the frame images respectively generated by the at least two of the plurality of image-capturing apparatuses. Thus, an appropriate frame-offset value R can be calculated for the adjustment-target image-capturing apparatus.

The offset calculator may calculate the offset amount for the adjustment-target image-capturing apparatus using a plurality of candidate frame-offset values, may calculate a plurality of the second index values β in consideration of the offset amount for the adjustment-target image-capturing apparatus, and may determine, as the frame-offset value R for the adjustment-target image-capturing apparatus, a candidate frame-offset value that is used when a second index value β′ that corresponds to a minimum of the plurality of the second index values β is calculated.

Further, the determined frame-offset value R is a candidate frame-offset value used when the second index value β′ corresponding to the minimum is calculated, with the candidate frame-offset value for the adjustment-target image-capturing apparatus being changed to all of the values in the specified range. In other words, the frame-offset value R is a frame-offset value used when an amount of an offset between a three-dimensional pose-point group and a feature-point group detected in each of the plurality of frame images captured by the adjustment-target image-capturing apparatus, is the minimum. Thus, appropriate frame-offset values R can be individually calculated for the respective image-capturing apparatuses. Accordingly, an offset between frames of images respectively generated by the plurality of image-capturing apparatuses that is due to an offset between image-capturing starting timings of the plurality of image-capturing apparatuses can be corrected for, and consequently, a three-dimensional pose can be calculated precisely.

The offset calculator may apply the frame-offset value R to a frame-image group that is included in the plurality of frame-image groups and generated by the adjustment-target image-capturing apparatus, may update the frame-offset-adjusted group by including the adjustment-target image-capturing apparatus in the frame-offset-adjusted group, and may calculate a frame-offset value R for another adjustment-target image-capturing apparatus using the plurality of frame images generated by each of the at least two of the plurality of image-capturing apparatuses, the at least two of the plurality of image-capturing apparatuses being included in the updated frame-offset-adjusted group. The offset calculator may repeat the applying, the updating, and the calculating until all of the plurality of image-capturing apparatuses are included in the frame-offset-adjusted group.

Consequently, the offset calculator determines the respective frame-offset values R for all of the image-capturing apparatuses. Frame-offset values R for images respectively generated by the plurality of image-capturing apparatuses can be determined in a state in which frames of the images respectively generated by the plurality of image-capturing apparatuses are offset due to image-capturing starting timings of the plurality of image-capturing apparatuses being offset and this may result in failing to calculate a three-dimensional pose accurately.

The information processing apparatus may further include an image-capturing apparatus determining section that determines a certain number and a certain arrangement of the plurality of image-capturing apparatuses as the number and an arrangement of the plurality of image-capturing apparatuses that are to be applied, the certain number and certain arrangement being applied when a second index value β″ is calculated, the second index value β″ corresponding to a minimum of a plurality of the second index values β calculated every time the number and an arrangement of the plurality of image-capturing apparatuses are changed.

According to the present embodiment, the number and an arrangement of the plurality of image-capturing apparatuses that are to be applied are a certain number and a certain arrangement of the plurality of image-capturing apparatuses that are applied when an amount of an offset between a three-dimensional pose-point group and a feature-point group detected by each of the plurality of image-capturing apparatuses, is the minimum. This makes it possible to determine an appropriate number and appropriate positions of the plurality of image-capturing apparatuses.

Frame rates of the plurality of image-capturing apparatuses may be equal to each other.

Thus, an appropriate frame-offset value R can be calculated for the adjustment-target image-capturing apparatus. Note that the frame rates do not necessarily have to be equal to each other. If the frame rate of each image-capturing apparatus is known, a group of images in each frame (for calculating α) can be selected in consideration of the period of the image-capturing apparatus. With respect to a method for considering the period, it is sufficient if, for example, selection of each frame and adjustment of a frame offset are performed with a period that is the least common multiple of the periods of all of the image-capturing apparatuses (a period of 1/30 seconds if there are the image-capturing apparatus with a period of 1/30 seconds and the image-capturing apparatus with a period of 1/60 seconds).

The at least two of the plurality of image-capturing apparatuses may respectively capture, for the same period of time, images of the object of which a shape, a pose, and/or a position is being changed.

A grater change in pose for each frame results in a greater change in the index value β with respect to a frame offset. This makes it possible to obtain a more accurate value of β′.

Each of the plurality of frame images may be a two-dimensional image or a depth image.

The offset calculator may detect the feature-point groups of the object in respective frame images that are respectively included in the pluralities of frame images, and may integrate the feature-point groups detected in the frame images respectively included in the pluralities of frame images to calculate the three-dimensional pose-point group of the object.

A three-dimensional pose acquiring section may generate a three-dimensional pose-point group using image processing or machine learning, or may acquire a three-dimensional pose-point group that is generated by an external information processing apparatus (not illustrated) through a network.

An information processing method according to an embodiment of the present disclosure includes acquiring a plurality of frame-image groups respectively generated by images of one object being respectively captured by a plurality of image-capturing apparatuses for the same period of time, each of the plurality of frame-image groups including a plurality of frame images; acquiring a three-dimensional pose-point group of the object that is calculated for each frame on the basis of feature-point groups that are respectively detected in the plurality of frame images that is included in each of the plurality of frame-image groups; calculating an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group; calculating a first index value α for each frame on the basis of the offset amounts; calculating a second index value β on the basis of a plurality of the first index values α calculated for the respective frames; and calculating a frame-offset value R for the adjustment-target image-capturing apparatus on the basis of the second index value β.

An information processing program according to an embodiment of the present disclosure causes an information processing apparatus to operate as a frame-image group acquiring section and an offset calculator; the frame-image group acquiring section acquiring a plurality of frame-image groups respectively generated by images of one object being respectively captured by a plurality of image-capturing apparatuses for the same period of time, each of the plurality of frame-image groups including a plurality of frame images; the offset calculator acquiring a three-dimensional pose-point group of the object that is calculated for each frame on the basis of feature-point groups that are respectively detected in the plurality of frame images that is included in each of the plurality of frame-image groups; the offset calculator calculating an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group; the offset calculator calculating a first index value α for each frame on the basis of the offset amounts; the offset calculator calculating a second index value β on the basis of a plurality of the first index values α calculated for the respective frames; the offset calculator calculating a frame-offset value R for the adjustment-target image-capturing apparatus on the basis of the second index value β.

### BRIEF DESCRIPTION OF DRAWINGS

FIG. 1 schematically illustrates an overview of an embodiment of the present disclosure.

FIG. 2 illustrates a configuration of an information processing apparatus according to an embodiment of the present disclosure.

FIG. 3 illustrates a flow of a first operation of the information processing apparatus (adjustment of a frame offset).

FIG. 4 schematically illustrates a method for adjusting a frame offset.

FIG. 5 illustrates a flow of a second operation of the information processing apparatus (a specific method for adjusting a frame offset).

FIG. 6 schematically illustrates a flow of a third operation of the information processing apparatus (adjustment of the number and positions of image-capturing apparatuses).

### MODE(S) FOR CARRYING OUT THE INVENTION

Embodiments according to the present disclosure will now be described below with reference to the drawings.

### 1. Overview of Embodiments

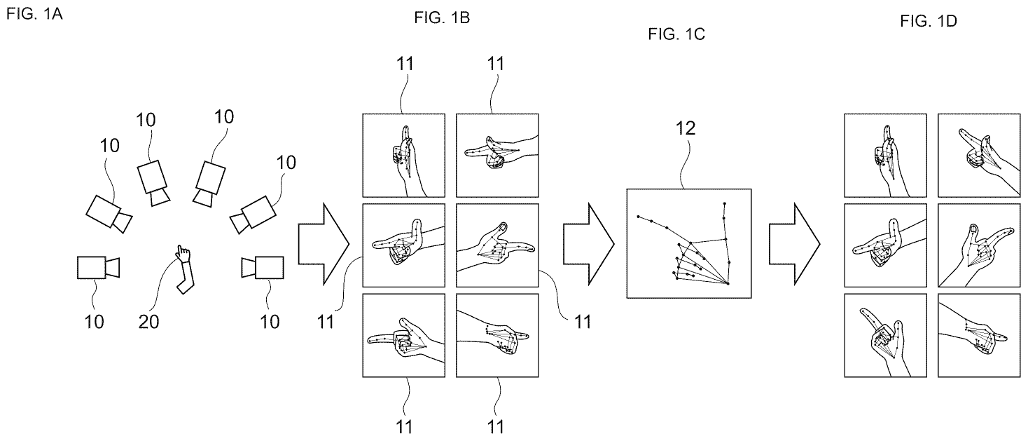

FIG. 1 schematically illustrates an overview of an embodiment of the present disclosure.

As illustrated in (A), image-capturing apparatuses 10 of a plurality of image-capturing apparatuses 10 are arranged at positions at which the image-capturing apparatuses 10 can capture respective images of one object 20. The image-capturing apparatuses 10 of the plurality of image-capturing apparatuses 10 are RGB cameras. A shape, a pose, and/or a position of the object 20 may be changed. Typically, the object 20 is a human hand.

As illustrated in (B), the image-capturing apparatuses 10 of the plurality of image-capturing apparatuses 10 capture images of one object 20 for the same period of time to respectively generate two-dimensional images (not still images but videos, and the same applies to the following description). A feature-point group is extracted from a two-dimensional image 11 that is generated by each of the plurality of image-capturing apparatuses 10.

As illustrated in (C), the feature-point groups respectively extracted from the two-dimensional images 11 respectively generated by the plurality of image-capturing apparatuses 10 are integrated to calculate a three-dimensional pose-point group 12 of the object 20, each feature-point group being a group of feature points of the object that is included in a corresponding one of a plurality of frame images. In order to calculate the three-dimensional pose-point group 12 of the object 20 accurately, it is necessary that frames of the two-dimensional images 11 respectively generated by the image-capturing apparatuses 10 of the plurality of image-capturing apparatuses 10 be matched to each other. If the frames are offset from each other, the feature-point groups respectively extracted from the two-dimensional images 11 offset in time from each other will be integrated. This may result in being able to accurately calculate the three-dimensional pose-point group 12 of the object 20. (D) illustrates the three-dimensional feature-point group illustrated in (C) being reprojected onto respective viewpoints. A difference between (D) and (B) is observed to calculate an offset amount.

In view of the circumstances described above, an offset between frames of the two-dimensional images 11 respectively generated by the image-capturing apparatuses 10 of a plurality of image-capturing apparatuses 10 is corrected for in the present embodiment.

Examples of use cases according to the present embodiment are described. For example, a plurality of image-capturing apparatuses 10 is placed at, for example, an end user's home. Examples of the plurality of image-capturing apparatuses 10 may be smartphones, tablet computers, personal computers, digital cameras, and digital video cameras. The user moves his/her hand or fingers at a position that enables each of the plurality of image-capturing apparatuses 10 to capture an image of his/her hand or fingers. The movement of the hand or fingers of the user is detected three-dimensionally to perform, for example, an operation of input to a computer game and an operation of input to a television or a computer. As another example, the plurality of image-capturing apparatuses 10 is placed at, for example, a factory. A worker works on tasks while moving his/her hand or fingers at a position that enables each of the plurality of image-capturing apparatuses 10 to capture an image of his/her hand or fingers. A working state of the worker can be monitored by three-dimensionally detecting the movement of his/her hand or fingers.

Image-capturing starting timings of the plurality of image-capturing apparatuses 10 will be surely offset especially when a user operates REC buttons of the plurality of image-capturing apparatuses 10 successively, which is one of the use cases described above. Consequently, frames for the respective image-capturing apparatuses 10 of the plurality of image-capturing apparatuses 10 will be surely offset. One of the purposes of the present embodiment is to overcome such an offset between frames that is due to an offset between image-capturing starting timings of the plurality of image-capturing apparatuses 10. However, the present embodiment is also useful in overcoming an offset between frames that is not due to the offset between the image-capturing starting timings.

In the use cases of the present embodiment, an offset between frames that is due to an offset between image-capturing starting timings of a plurality of image-capturing apparatuses 10 is overcome before, for example, an operation of input to a computer game is started (that is, before play is started). This makes it possible to play a computer game in a state in which an offset between frames that is due to an offset between image-capturing starting timings of a plurality of image-capturing apparatuses 10 has been overcome.

### 2. Configuration of Information Processing Apparatus

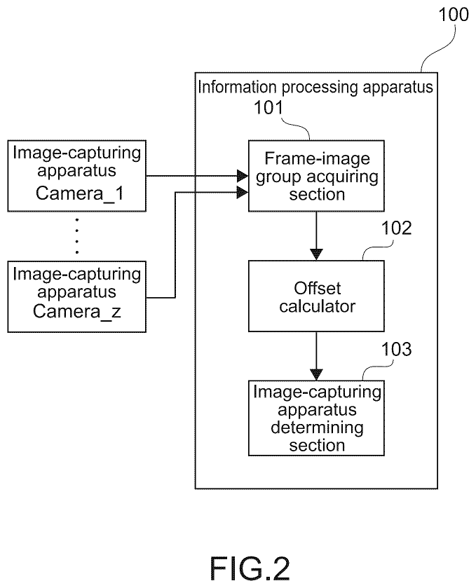

FIG. 2 illustrates a configuration of an information processing apparatus according to an embodiment of the present disclosure.

An information processing apparatus 100 is connected to a plurality of image-capturing apparatuses Camera_1 to Camera_Z through a USB or a network such as the Internet to be capable of communicating with the plurality of image-capturing apparatuses Camera_1 to Camera_Z. The information processing apparatus 100 is, for example, a server apparatus provided on a cloud, or a computer connected using a USB.

The information processing apparatus 100 operates as a frame-image group acquiring section 101, an offset calculator 102, and an image-capturing apparatus determining section 103 by a CPU loading, into a RAM, an information processing program stored in a ROM and executing the program.

### 3. Flow of First Operation of Information Processing Apparatus (Adjustment of Frame Offset)

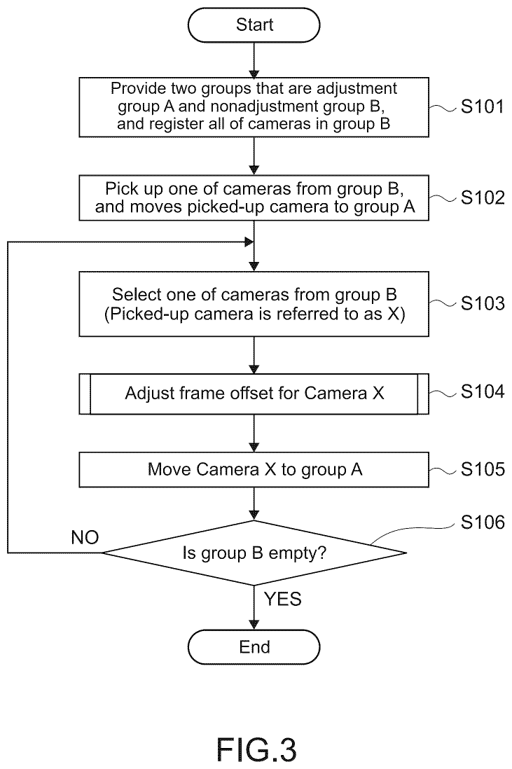

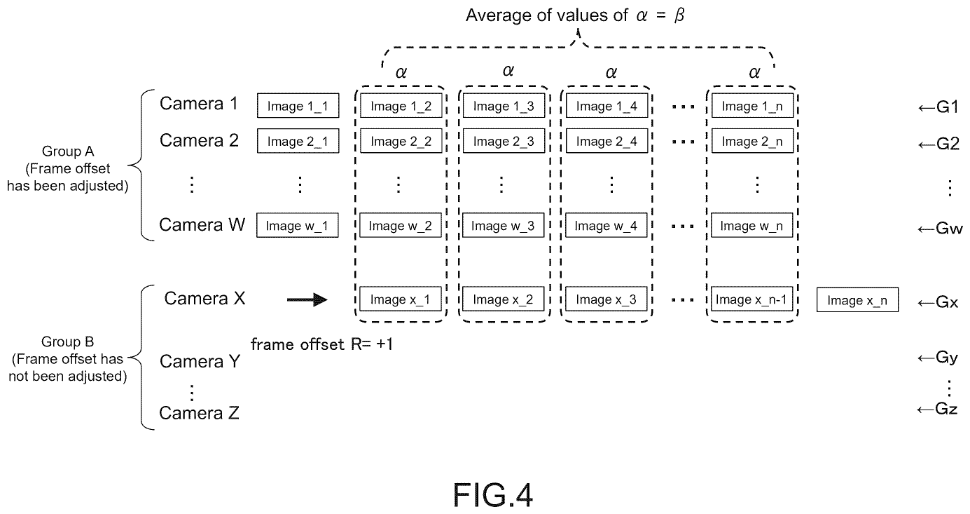

FIG. 3 illustrates a flow of a first operation of the information processing apparatus (adjustment of a frame offset). FIG. 4 schematically illustrates a method for adjusting a frame offset.

A precondition for the operation is described. The plurality of image-capturing apparatuses Camera_1 to Camera_Z is placed. Frame rates of the plurality of image-capturing apparatuses Camera_1 to Camera_Z are equal to each other. Calibration has been performed on the plurality of image-capturing apparatuses Camera_1 to Camera_Z. In other words, calibration (adjustment) has been performed on intrinsic parameters for the plurality of image-capturing apparatuses Camera_1 to Camera_Z (a focal length of and an optical distortion in each of the plurality of image-capturing apparatuses Camera_1 to Camera_Z), and on extrinsic parameters for the plurality of image-capturing apparatuses Camera_1 to Camera_Z (a rotation parameter and a translation parameter for the image-capturing apparatuses Camera_1 to Camera_Z). Note that the frame rates do not necessarily have to be equal to each other. If the frame rate of each image-capturing apparatus is known, a group of images in each frame (for calculating α) can be selected in consideration of the period of the image-capturing apparatus. With respect to a method for considering the period, it is sufficient if, for example, selection of each frame and adjustment of a frame offset are performed with a period that is the least common multiple of the periods of all of the image-capturing apparatuses (a period of 1/30 seconds if there are the image-capturing apparatus with a period of 1/30 seconds and the image-capturing apparatus with a period of 1/60 seconds).

The image-capturing apparatuses Camera_1 to Camera_Z of the plurality of image-capturing apparatuses Camera_1 to Camera_Z respectively capture, for the same period of time, images of the object 20 of which a shape, a pose, and/or a position is being changed (for example, a human hand that is being opened and closed or is being moved upward and downward), and respectively generate frame-image groups G1 to Gz.

The frame-image group acquiring section 101 acquires the frame images G1 to Gz respectively generated by images of one object 20 being respectively captured by the plurality of image-capturing apparatuses Camera_1 to Camera_Z for the same period of time. The frame-image groups G1 to Gz each include a plurality of frame images Image_N_1 to Image_N_n. For example, the frame-image group G1 generated by the image-capturing apparatus Camera_1 includes a plurality of frame images Image_1_1 to Image_1_n, as illustrated in FIG. 4. Each of the frame images Image_N_1 to Image_N_n is a depth image or a two-dimensional image.

The offset calculator 102 classifies the plurality of image-capturing apparatuses Camera_1 to Camera_Z into a frame-offset-adjusted group A and a frame-offset-nonadjusted group B. The offset calculator 102 registers all of the image-capturing apparatuses Camera_1 to Camera_Z in the frame-offset-nonadjusted group B, which is set to be a default (Step S101).

The offset calculator 102 picks up the image-capturing apparatus Camera_1 from the frame-offset-nonadjusted group B, and registers the picked-up image-capturing apparatus Camera_1 in the frame-offset-adjusted group A (Step S102). Consequently, the frame-offset-adjusted group A includes the image-capturing apparatus Camera_1, and the frame-offset-nonadjusted group B includes the remaining image-capturing apparatuses that are the image-capturing apparatuses Camera_2 to Camera_Z. The image-capturing apparatus Camera_1 registered in the frame-offset-adjusted group A may be any image-capturing apparatus, or may be an image-capturing apparatus with which feature-point groups detected in the plurality of frame images Image_1_1 to Image_1_n are highly reliable.

The offset calculator 102 picks up an image-capturing apparatus Camera_X as a frame-offset-adjustment target from the frame-offset-nonadjusted group B (Step S103), and a frame offset is adjusted for the image-capturing apparatus Camera_X (Step S104). The picked-up image-capturing apparatus Camera_X is hereinafter referred to as an adjustment-target image-capturing apparatus Camera_X.

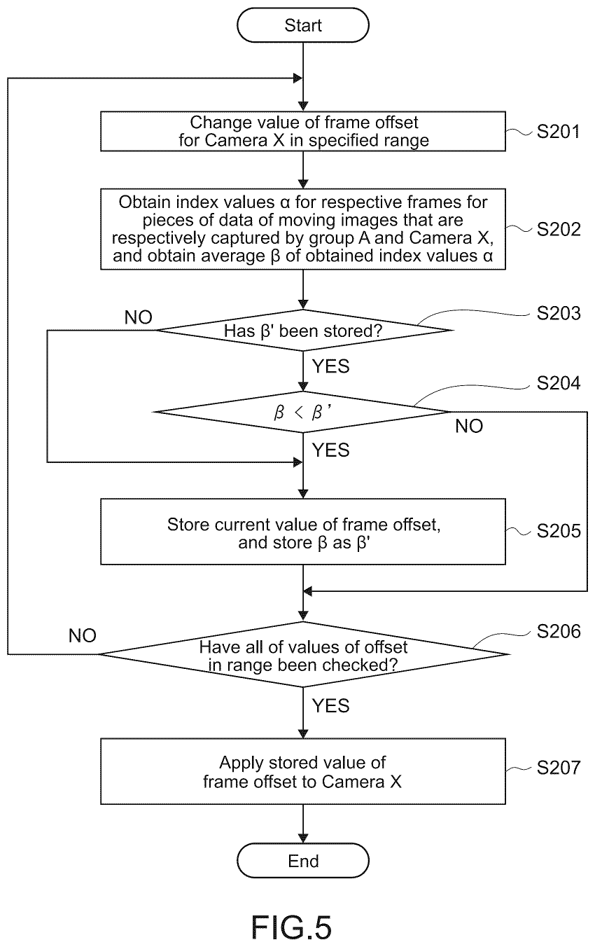

FIG. 5 illustrates a flow of a second operation of the information processing apparatus (a specific method for adjusting a frame offset).

The offset calculator 102 changes a candidate frame-offset value for the adjustment-target image-capturing apparatus Camera_X in a specified range of from −R to +R (Step S201).

The offset calculator 102 calculates a first index value a for each frame. The first index value a is obtained by averaging differences (distances) obtained for respective viewpoints (for respective image-capturing apparatuses), each difference being a difference between a position of a two-dimensional feature point in a certain frame image and a position of a corresponding two-dimensional feature point in another frame image, the certain frame image being a frame image that is captured at each of the viewpoints (using each of the image-capturing apparatuses) and in which a two-dimensional feature-point group including the two-dimensional feature point is detected, the other frame image being a frame image of which the corresponding two-dimensional feature point is included in a two-dimensional feature-point group obtained by a three-dimensional feature-point group being reprojected onto the respective viewpoints, the three-dimensional feature-point group being calculated on the basis of the two-dimensional feature-point groups detected in the certain frame images captured at the respective viewpoints. The use of an image that is captured by the adjustment-target image-capturing apparatus Camera_X and in which a frame offset occurs results in deforming an obtained three-dimensional pose-point group. This results in a large difference from a result of detection performed at each viewpoint. The first index value α is obtained using all of the differences. The first index value α is calculated from frame images respectively generated by at least two image-capturing apparatuses (here, the image-capturing apparatus Camera_1 and adjustment-target image-capturing apparatus Camera_X being included in the frame-offset-adjusted group A).

For example, first, the offset calculator 102 obtains a three-dimensional pose group using frame images Image_1_2 to Image_W_2 that are respectively generated by the image-capturing apparatuses Camera_1 to Camera_W and using a frame image Image_X_1 that is generated by the image-capturing apparatus Camera_X, and projects the three-dimensional pose group onto frame images at the respective viewpoints (the respective image-capturing apparatuses). The offset calculator 102 calculates an average of offset amounts as the first index value a, the offset amount being an amount of an offset between a three-dimensional pose group projected onto each frame image, and a feature-point group for a corresponding two-dimensional pose. The frame image Image_X_1 generated by the image-capturing apparatus Camera_X is a frame image that corresponds to the frame images Image_1_2 to Image_W_2 when the candidate frame-offset value is assumed to be +1. In other words, the offset calculator 102 calculates a plurality of first index values α when the candidate frame-offset value is assumed to be +1. Note that, when the candidate frame-offset value is assumed to be +1, there is no frame image that is generated by the adjustment-target image-capturing apparatus Camera_X and corresponds to a frame image Image_1_1 that is generated by the image-capturing apparatus Camera_1. In this case, the offset calculator 102 excludes the frame image Image_1_1 generated by the image-capturing apparatus Camera_1 from calculation targets for calculating the first index values α.

The offset calculator 102 calculates a second index value β on the basis of a plurality of first index values α calculated for the respective frames. The offset calculator 102 calculates the second index value β in consideration of an offset amount for the adjustment-target image-capturing apparatus Camera_X. The second index value β is an average of the plurality of first index values α. In other words, the offset calculator 102 calculates, as the second index value β, an average of all of the first index values α calculated when the candidate frame-offset value is assumed to be +1 (Step S202).

The offset calculator 102 determines whether a second index value β′ that is a minimum of the second index values β calculated for the current adjustment-target image-capturing apparatus Camera_X has been stored (Step S203). In this example, the candidate frame-offset value is assumed to be +1 when the second index value β is calculated for the first time. Thus, the second index value β′ corresponding to the minimum has not been stored (NO in Step S203). The offset calculator 102 stores, as the second index value B′ corresponding to the minimum for the adjustment-target image-capturing apparatus Camera_X, the second index value β calculated when the candidate frame-offset value is assumed to be +1 with respect to the adjustment-target image-capturing apparatus Camera_X (Step S205).

On the other hand, the second index value β′ corresponding to the minimum has been stored when the second index value β is calculated for the second and subsequent times, with the candidate frame-offset value being changed in the specified range of from −R to +R, (YES in Step S203). In this case, when a most recently calculated second index value β is smaller than the stored second index value β′ corresponding to the minimum (YES in Step S204), the offset calculator 102 stores the most recently calculated second index value β as the second index value β′ corresponding to the minimum, that is, updates the second index value β′ corresponding to the minimum (Step S205). On the other hand, when the most recently calculated second index value β is larger than or equal to the stored second index value β′ corresponding to the minimum (NO in Step S204), the offset calculator 102 does not update the second index value β′ corresponding to the minimum.

When the candidate frame-offset value for the adjustment-target image-capturing apparatus Camera_X has been changed using all of the values in the specified range of from −R to +R (YES in Step S206), the offset calculator 102 stores the second index value β′, which is a minimum of calculated second index values. The offset calculator 102 determines, as a frame-offset value R for the adjustment-target image-capturing apparatus Camera_X, a candidate frame-offset value used when the second index value β′ corresponding to the minimum is calculated (Step S207).

The offset calculator 102 applies the frame-offset value R to a frame-image group generated by the adjustment-target image-capturing apparatus Camera_X, and updates the adjusted group A by including the adjustment-target image-capturing apparatus Camera_X in the frame-offset-adjusted group A (Step S105). Until all of the image-capturing apparatuses are included in the frame-offset-adjusted group, the offset calculator 102 repeatedly calculates the frame-offset value R for another adjustment-target image-capturing apparatus using a plurality of frame images generated by each of the image-capturing apparatuses included in the updated frame-offset-adjusted group A. In other words, the offset calculator 102 repeatedly performs the processing until the frame-offset-nonadjusted group B becomes empty (Step S106). In other words, the offset calculator 102 repeatedly performs the processing until the respective frame-offset values R for all of the image-capturing apparatuses Camera_1 to Camera_Z are determined and all of the image-capturing apparatuses Camera_1 to Camera_Z are included in the frame-offset-adjusted group A.

As described above, the offset calculator 102 determines the respective frame-offset values R for all of the image-capturing apparatuses Camera_1 to Camera_Z. Accordingly, frame-offset values R for two-dimensional images respectively generated by the plurality of image-capturing apparatuses Camera_1 to Camera_Z can be determined in a state in which frames of the two-dimensional images respectively generated by the plurality of image-capturing apparatuses Camera_1 to Camera_Z are offset due to image-capturing starting timings of the plurality of image-capturing apparatuses Camera_1 to Camera_Z being offset and this may result in failing to calculate a three-dimensional pose accurately.

Further, the determined frame-offset value R is a candidate frame-offset value used when the second index value β′ corresponding to the minimum is calculated, with the candidate frame-offset value for the adjustment-target image-capturing apparatus Camera_X being changed to all of the values in the specified range of from −R to +R. In other words, the frame-offset value R is a frame-offset value used when an amount of an offset between a three-dimensional pose-point group and a feature-point group detected in each of the plurality of frame images Image_X_1 to Image_X_n captured by the adjustment-target image-capturing apparatus Camera_X, is the minimum. Thus, appropriate frame-offset values R can be individually calculated for the respective image-capturing apparatuses Camera_1 to Camera_Z. Accordingly, an offset between frames of two-dimensional images respectively generated by the plurality of image-capturing apparatuses Camera_1 to Camera_Z that is due to an offset between image-capturing starting timings of the plurality of image-capturing apparatuses Camera_1 to Camera_Z can be corrected for, and consequently, a three-dimensional pose can be calculated precisely.

### 4. Flow of Third Operation of Information Processing Apparatus (Adjustment of Number and Positions of Image-Capturing Apparatuses)

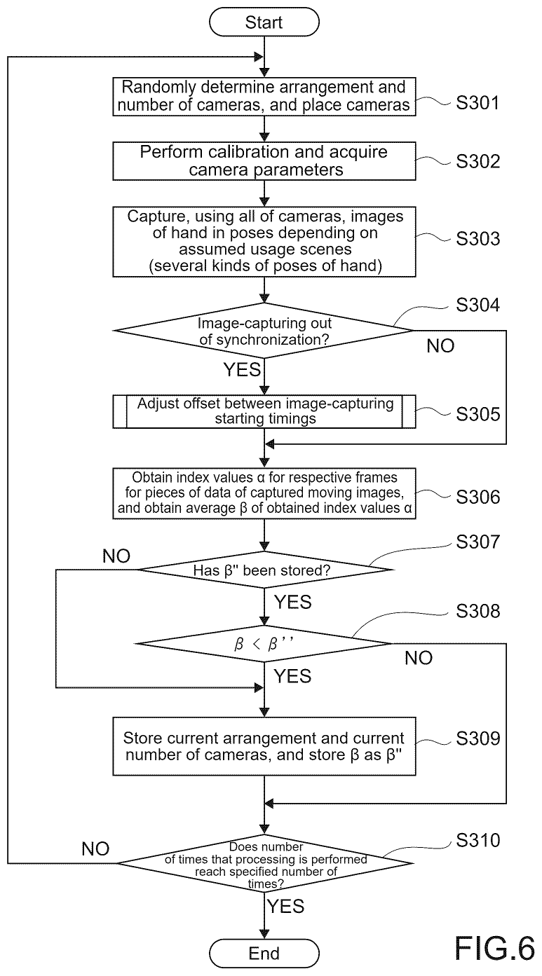

FIG. 6 schematically illustrates a flow of a third operation of the information processing apparatus (adjustment of the number and positions of image-capturing apparatuses).

The number and positions of a plurality of image-capturing apparatuses can be adjusted using the flows of the first and third operations (adjustment of a frame offset) (FIGS. 3 to 5) of the information processing apparatus 100 according to the present embodiment. Specifically, a user manually changes the number and positions of the plurality of image-capturing apparatuses Camera_1 to Camera_Z, and performs the processing of the flow of the first operation (adjustment of a frame offset) (FIGS. 4 and 5) of the information processing apparatus 100 multiple times. Then, a certain number and a certain arrangement of the plurality of image-capturing apparatuses Camera_1 to Camera_Z are determined to be the number and an arrangement of the plurality of image-capturing apparatuses Camera_1 to Camera_Z that are to be applied, the certain number and certain arrangement being applied when a second index value β″ is calculated, the second index value 62 ″ corresponding to a minimum of a plurality of second index values β calculated every time the number and an arrangement of the plurality of image-capturing apparatuses Camera_1 to Camera_Z are changed.

The user randomly determines the number and positions of the plurality of image-capturing apparatuses Camera_1 to Camera_Z, and places the plurality of image-capturing apparatuses Camera_1 to Camera_Z (Step S301). Calibration is performed on the plurality of image-capturing apparatuses Camera_1 to Camera_Z. In other words, calibration (adjustment) is performed on intrinsic parameters for the plurality of image- capturing apparatuses Camera_1 to Camera_Z (a focal length of and an optical distortion in each of the image-capturing apparatuses Camera_1 to Camera_Z), and on extrinsic parameters for the plurality of image-capturing apparatuses Camera_1 to Camera_Z (a rotation parameter and a translation parameter for the image-capturing apparatuses Camera_1 to Camera_Z) (Step S302).

The image-capturing apparatuses Camera_1 to Camera_Z of the plurality of image-capturing apparatuses Camera_1 to Camera_Z respectively capture, for the same period of time, images of the object 20 of which a shape, a pose, and/or a position is being changed (for example, a human hand that is being opened and closed or is being moved upward and downward. During such a movement of the hand, a position and a pose of the hand favorably match to an assumed usage scene), and respectively generate frame-image groups G1 to Gz.

The frame-image group acquiring section 101 acquires the frame images G1 to Gz respectively generated by the images of one object 20 being respectively captured by the plurality of image-capturing apparatuses Camera_1 to Camera_Z for the same period of time. The frame-image groups G1 to Gz each include a plurality of frame images Image_N_1 to Image_N_n. Each of the frame images Image_N_1 to Image_N_n is a two-dimensional image (Step S303).

When the image-capturing apparatuses Camera_1 to Camera_Z of the plurality of image-capturing apparatuses Camera_1 to Camera_Z perform image-capturing out of synchronization with each other (YES in Step S304), the offset calculator 102 performs the processes of Steps S101 to S106 in FIG. 3 (the process of Step S104 includes the processes of Steps S201 to S207 in FIG. 5) to calculate respective frame-offset values R for the plurality of image-capturing apparatuses Camera_1 to Camera_Z (Step S305).

The image-capturing apparatus determining section 103 applies the calculated (Step 305) frame-offset values R to the plurality of frame-image groups G1 to Gz respectively generated by the plurality of image-capturing apparatuses Camera_1 to Camera_Z, calculates a first index value α for each frame, and calculates a second index value β that is an average of a plurality of the first index values a (Step S306).

The image-capturing apparatus determining section 103 determines whether the second index value 62 ″ corresponding to a minimum of the second index values β calculated for a current number of the plurality of image-capturing apparatuses Camera_1 to Camera_Z in a current arrangement has been stored (Step S307). In this example, the number and the arrangement of the plurality of image-capturing apparatuses Camera_1 to Camera_Z are randomly determined and the plurality of image-capturing apparatuses Camera_1 to Camera_Z is placed for the first time. Thus, the second index value β″ corresponding to the minimum has not been stored (NO in Step S307). The image-capturing apparatus determining section 103 stores, as the second index value 62 ″ corresponding to the minimum, the second index value β calculated for the current number of the plurality of image-capturing apparatuses Camera_1 to Camera_Z in the current arrangement, and stores the current number and arrangement of the image-capturing apparatuses Camera_1 to Camera_Z (Step S309).

On the other hand, when the user randomly determines the number and the positions of the plurality of image-capturing apparatuses Camera_1 to Camera_Z and places the plurality of image-capturing apparatuses Camera_1 to Camera_Z for the second and subsequent times, the second index value β″ corresponding to the minimum has been stored (YES in Step S307). In this case, when a most recently calculated second index value β is smaller than the stored second index value β″ corresponding to the minimum (YES in Step S308), the image-capturing apparatus determining section 103 stores the most recently calculated second index value β as the second index value β″ corresponding to the minimum, that is, updates the second index value β″ corresponding to the minimum, and stores a current number and a current arrangement of the plurality of image-capturing apparatuses Camera_1 to Camera_Z (Step S309). On the other hand, when the most recently calculated second index value β is larger than or equal to the stored second index value β″ corresponding to the minimum (NO in Step S308), the image-capturing apparatus determining section 103 does not update the second index value β″ corresponding to the minimum or store the current number and arrangement of the plurality of image-capturing apparatuses Camera_1 to Camera_Z.

The image-capturing apparatus determining section 103 repeatedly performs the processing until the number of times that the processing is performed reaches a specified number of times (Step S310).

When the number and the arrangement are changed and the second index value β for the plurality of image-capturing apparatuses Camera_1 to Camera_Z is calculated a specified number of times, the image-capturing apparatus determining section 103 stores a second index value β″ corresponding to a minimum of the calculated second index values β, and stores a certain number and a certain arrangement of the plurality of image-capturing apparatuses Camera_1 to Camera_Z that are applied when the stored second index value β″ is calculated. The image-capturing apparatus determining section 103 determines, as the number and an arrangement of the plurality of image-capturing apparatuses Camera_1 to Camera_Z that are to be applied, the certain number and certain arrangement of the image-capturing apparatuses Camera_1 to Camera_Z that are applied when the second index value β″ corresponding to the minimum is calculated (YES in Step S310).

The image-capturing apparatus determining section 103 determines the number and an arrangement of the plurality of image-capturing apparatuses Camera_1 to Camera_Z that are to be applied, as described above. The number and the arrangement of the plurality of image-capturing apparatuses Camera_1 to Camera_Z are a certain number and a certain arrangement of the plurality of image-capturing apparatuses Camera_1 to Camera_Z that are applied when an amount of an offset between a three-dimensional pose-point group and a feature-point group detected by each of the plurality of image-capturing apparatuses Camera_1 to Camera_Z, is the minimum. This makes it possible to determine an appropriate number and appropriate positions of the plurality of image-capturing apparatuses Camera_1 to Camera_Z.

Further, according to the present embodiment, the determination of an appropriate number of the plurality of image-capturing apparatuses Camera_1 to Camera_Z makes it possible to reduce the number of the plurality of image-capturing apparatuses Camera_1 to Camera_Z, and thus to reduce an amount of information to be processed and costs.

The present disclosure may also include the following configurations.
(1) An information processing apparatus, including:
   a frame-image group acquiring section that acquires a plurality of frame-image groups respectively generated by images of one object being respectively captured by a plurality of image-capturing apparatuses for the same period of time, each of the plurality of frame-image groups including a plurality of frame images; and
   an offset calculator that
      acquires a three-dimensional pose-point group of the object that is calculated for each frame on the basis of feature-point groups that are respectively detected in the plurality of frame images that is included in each of the plurality of frame-image groups,
      calculates an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group,
      calculates a first index value α for each frame on the basis of the offset amounts,
      calculates a second index value β on the basis of a plurality of the first index values α calculated for the respective frames, and
      calculates a frame-offset value R for the adjustment-target image-capturing apparatus on the basis of the second index value β.
(2) The information processing apparatus according to (1), in which
   the first index value α is an average of amounts of an offset between the frame images respectively generated by the at least two of the plurality of image-capturing apparatuses.
(3) The information processing apparatus according to (1) or (2), in which
   the second index value β is an average of the plurality of the first index values α.
(4) The information processing apparatus according to any one of (1) to (3), in which
   the offset calculator
      calculates the offset amount for the adjustment-target image-capturing apparatus using a plurality of candidate frame-offset values,
      calculates a plurality of the second index values β in consideration of the offset amount for the adjustment-target image-capturing apparatus, and
      determines, as the frame-offset value R for the adjustment-target image-capturing apparatus, a candidate frame- offset value that is used when a second index value β′ that corresponds to a minimum of the plurality of the second index values β is calculated.
(5) The information processing apparatus according to any one of (1) to (4), in which
   the offset calculator
      applies the frame-offset value R to a frame-image group that is included in the plurality of frame-image groups and generated by the adjustment-target image-capturing apparatus,
      updates the frame-offset-adjusted group by including the adjustment-target image-capturing apparatus in the frame-offset-adjusted group, and
      calculates a frame-offset value R for another adjustment-target image-capturing apparatus using the plurality of frame images generated by each of the at least two of the plurality of image-capturing apparatuses, the at least two of the plurality of image-capturing apparatuses being included in the updated frame-offset-adjusted group,
   the offset calculator repeating the applying, the updating, and the calculating until all of the plurality of image-capturing apparatuses are included in the frame-offset-adjusted group.
(6) The information processing apparatus according to any one of (1) to (5), further including
   an image-capturing apparatus determining section that determines a certain number and a certain arrangement of the plurality of image-capturing apparatuses as the number and an arrangement of the plurality of image-capturing apparatuses that are to be applied, the certain number and certain arrangement being applied when a second index value β″ is calculated, the second index value β″ corresponding to a minimum of a plurality of the second index values β calculated every time the number and an arrangement of the plurality of image-capturing apparatuses are changed.
(7) The information processing apparatus according to any one of (1) to (6), in which
   frame rates of the plurality of image-capturing apparatuses are equal to each other.
(8) The information processing apparatus according to any one of (1) to (7), in which
   the at least two of the plurality of image-capturing apparatuses respectively capture, for the same period of time, images of the object of which a shape, a pose, and/or a position is being changed.
(9) The information processing apparatus according to any one of (1) to (8), in which
   each of the plurality of frame images is a two-dimensional image.
(10) The information processing apparatus according to any one of (1) to (9), in which
   the offset calculator
      detects the feature-point groups of the object in respective frame images that are respectively included in the pluralities of frame images, and
      integrates the feature-point groups detected in the frame images respectively included in the pluralities of frame images to calculate the three-dimensional pose-point group of the object.
(11) An information processing method, including:
   acquiring a plurality of frame-image groups respectively generated by images of one object being respectively captured by a plurality of image-capturing apparatuses for the same period of time, each of the plurality of frame-image groups including a plurality of frame images;
   acquiring a three-dimensional pose-point group of the object that is calculated for each frame on the basis of feature-point groups that are respectively detected in the plurality of frame images that is included in each of the plurality of frame-image groups;
   calculating an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group;
   calculating a first index value α for each frame on the basis of the offset amounts;
   calculating a second index value β on the basis of a plurality of the first index values α calculated for the respective frames; and
   calculating a frame-offset value R for the adjustment-target image-capturing apparatus on the basis of the second index value β.
(12) An information processing program that causes an information processing apparatus to operate as a frame-image group acquiring section and an offset calculator,
   the frame-image group acquiring section acquiring a plurality of frame-image groups respectively generated by images of one object being respectively captured by a plurality of image-capturing apparatuses for the same period of time, each of the plurality of frame-image groups including a plurality of frame images,
   the offset calculator acquiring a three-dimensional pose-point group of the object that is calculated for each frame on the basis of feature-point groups that are respectively detected in the plurality of frame images that is included in each of the plurality of frame-image groups,
   the offset calculator calculating an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group,
   the offset calculator calculating a first index value α for each frame on the basis of the offset amounts,
   the offset calculator calculating a second index value β on the basis of a plurality of the first index values α calculated for the respective frames,
   the offset calculator calculating a frame-offset value R for the adjustment-target image-capturing apparatus on the basis of the second index value β.
(13) A non-transitory computer-readable recording medium that records therein an information processing program that causes an information processing apparatus to operate as a frame-image group acquiring section and an offset calculator,
   the frame-image group acquiring section acquiring a plurality of frame-image groups respectively generated by images of one object being respectively captured by a plurality of image-capturing apparatuses for the same period of time, each of the plurality of frame-image groups including a plurality of frame images,
   the offset calculator acquiring a three-dimensional pose-point group of the object that is calculated for each frame on the basis of feature-point groups that are respectively detected in the plurality of frame images that is included in each of the plurality of frame-image groups,
   the offset calculator calculating an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group,
   the offset calculator calculating a first index value α for each frame on the basis of the offset amounts,
   the offset calculator calculating a second index value β on the basis of a plurality of the first index values α calculated for the respective frames,
   the offset calculator calculating a frame-offset value R for the adjustment-target image-capturing apparatus on the basis of the second index value β.

The embodiments and the modifications of the present technology have been described above. Of course the present technology is not limited to the embodiments described above, and various modifications may be made thereto without departing from the scope of the present technology.

### REFERENCE SIGNS LIST

10 image-capturing apparatus
100 information processing apparatus
101 frame-image group acquiring section
102 offset calculator
103 image-capturing apparatus determining section

1. An information processing apparatus, comprising:
a frame-image group acquiring section that acquires a plurality of frame-image groups respectively generated by images of one object being respectively captured by a plurality of image-capturing apparatuses for the same period of time, each of the plurality of frame-image groups including a plurality of frame images; and
an offset calculator that
acquires a three-dimensional pose-point group of the object that is calculated for each frame on a basis of feature-point groups that are respectively detected in the plurality of frame images that is included in each of the plurality of frame-image groups,
calculates an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group,
calculates a first index value α for each frame on a basis of the offset amounts,
calculates a second index value β on a basis of a plurality of the first index values α calculated for the respective frames, and
calculates a frame-offset value R for the adjustment-target image-capturing apparatus on a basis of the second index value β.

2. The information processing apparatus according to claim 1, wherein
the first index value α is an average of amounts of an offset between the frame images respectively generated by the at least two of the plurality of image-capturing apparatuses.

3. The information processing apparatus according to claim 1, wherein
the second index value β is an average of the plurality of the first index values α.

4. The information processing apparatus according to claim 1, wherein
the offset calculator
calculates the offset amount for the adjustment-target image-capturing apparatus using a plurality of candidate frame-offset values,
calculates a plurality of the second index values β in consideration of the offset amount for the adjustment-target image-capturing apparatus, and
determines, as the frame-offset value R for the adjustment-target image-capturing apparatus, a candidate frame-offset value that is used when a second index value β′ that corresponds to a minimum of the plurality of the second index values β is calculated.

5. The information processing apparatus according to claim 1, wherein
the offset calculator
applies the frame-offset value R to a frame-image group that is included in the plurality of frame-image groups and generated by the adjustment-target image-capturing apparatus,
updates the frame-offset-adjusted group by including the adjustment-target image-capturing apparatus in the frame-offset-adjusted group, and
calculates a frame-offset value R for another adjustment-target image-capturing apparatus using the plurality of frame images generated by each of the at least two of the plurality of image-capturing apparatuses, the at least two of the plurality of image-capturing apparatuses being included in the updated frame-offset-adjusted group,
the offset calculator repeating the applying, the updating, and the calculating until all of the plurality of image-capturing apparatuses are included in the frame-offset-adjusted group.

6. The information processing apparatus according to claim 1, further comprising
an image-capturing apparatus determining section that determines a certain number and a certain arrangement of the plurality of image-capturing apparatuses as the number and an arrangement of the plurality of image-capturing apparatuses that are to be applied, the certain number and certain arrangement being applied when a second index value β″ is calculated, the second index value β″ corresponding to a minimum of a plurality of the second index values β calculated every time the number and an arrangement of the plurality of image-capturing apparatuses are changed.

7. The information processing apparatus according to claim 1, wherein
frame rates of the plurality of image-capturing apparatuses are equal to each other.

8. The information processing apparatus according to claim 1, wherein
the at least two of the plurality of image-capturing apparatuses respectively capture, for the same period of time, images of the object of which a shape, a pose, and/or a position is being changed.

9. The information processing apparatus according to claim 1, wherein
each of the plurality of frame images is a two-dimensional image.

10. The information processing apparatus according to claim 1, wherein
the offset calculator
detects the feature-point groups of the object in respective frame images that are respectively included in the pluralities of frame images, and
integrates the feature-point groups detected in the frame images respectively included in the pluralities of frame images to calculate the three-dimensional pose-point group of the object.

11. An information processing method, comprising:
acquiring a plurality of frame-image groups respectively generated by images of one object being respectively captured by a plurality of image-capturing apparatuses for the same period of time, each of the plurality of frame-image groups including a plurality of frame images;
acquiring a three-dimensional pose-point group of the object that is calculated for each frame on a basis of feature-point groups that are respectively detected in the plurality of frame images that is included in each of the plurality of frame-image groups;
calculating an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group;
calculating a first index value α for each frame on a basis of the offset amounts;
calculating a second index value β on a basis of a plurality of the first index values α calculated for the respective frames; and
calculating a frame-offset value R for the adjustment-target image-capturing apparatus on a basis of the second index value β.

12. An information processing program that causes an information processing apparatus to operate as a frame-image group acquiring section and an offset calculator,
the frame-image group acquiring section acquiring a plurality of frame-image groups respectively generated by images of one object being respectively captured by a plurality of image-capturing apparatuses for the same period of time, each of the plurality of frame-image groups including a plurality of frame images,
the offset calculator acquiring a three-dimensional pose-point group of the object that is calculated for each frame on a basis of feature-point groups that are respectively detected in the plurality of frame images that is included in each of the plurality of frame-image groups,
the offset calculator calculating an amount of an offset between the feature-point group and the three-dimensional pose-point group for each frame, the feature-point group being detected in a frame image that is included in the plurality of frame images and generated by each of at least one of the plurality of image-capturing apparatuses and an adjustment-target image-capturing apparatus, the at least one of the plurality of image-capturing apparatuses being included in a frame-offset-adjusted group, the adjustment-target image-capturing apparatus being one of the plurality of image-capturing apparatuses that is not included the frame-offset-adjusted group,
the offset calculator calculating a first index value α for each frame on a basis of the offset amounts,
the offset calculator calculating a second index value β on a basis of a plurality of the first index values α calculated for the respective frames,
the offset calculator calculating a frame-offset value R for the adjustment-target image-capturing apparatus on a basis of the second index value β.
